(19) United States
(12) Patent Application Publication
(10) Pub. No.: US 2016/0363466 A1
(43) Pub. Date: Dec. 15, 2016

(54) METHOD FOR SECURING A SENSOR TO A SUPPORT

(71) Applicant: VALEO SYSTEMES DE CONTROLE MOTEUR, Cergy Saint Christophe (FR)

(72) Inventors: Florent Rampillon, Maisons Lafitte (FR); Manuela Mateos-Bugatti, Osny (FR); Didier Le Cunff, Carriere Sous Poissy (FR); Christophe Lopes, Sannois (FR)

(73) Assignee: Valeo Systemes de Controle Moteur, Cergy Saint Christophe (FR)

(21) Appl. No.: 15/031,847

(22) PCT Filed: Oct. 22, 2014
(86) PCT No.: PCT/FR2014/052679

§ 371 Date: Aug. 3, 2016

(30) Foreign Application Priority Data
Oct. 25, 2013 (FR) 1360431

(51) Int. Cl. G01D 11/30

(52) U.S. Cl. CPC G01D 11/30

(57) ABSTRACT

Method for securing a sensor (1) to a support (2), the support (2) comprising a receiving zone (16) for the sensor (1) and a crimping zone (17), the sensor (1) comprising a housing (20) provided with a projecting zone (25), wherein, in said method:—the sensor (1) is moved next to the receiving zone (16) of the support (2) and brought into contact with all or part thereof, and—all or part of the crimping zone (17) is deformed such that said portion(s) of the crimping zone (17) that is/are deformed in this way press(es) against all or part of the projection zone (25) so as to keep the sensor (1) in position with respect to the support (2).

The present invention relates to the securing of a sensor to a support.

The invention in particular, but not exclusively, applies to the automobile field. The sensor is for example a position sensor, and the support is for example integrated into a cover of an electromechanical component of the air circuit of a vehicle heat engine. The electromechanical component is for example a valve.

Within the meaning of the invention, “heat engine air circuit” refers to the circuit between the intake inlet and the exhaust outlet of the heat engine. The valve may be positioned in the intake circuit, the exhaust circuit, or in a recirculation loop through which the exhaust gases reinjected at the intake (EGR) pass.

It in particular involves a cover for an exhaust gas recirculation valve.

To secure the sensor to the support, it is known to overmold it on the support, or to keep it in position on the latter using a resin.

The known means for securing the sensor to the support are not satisfactory, since they assume additional costly steps.

There is a need to allow a sensor to be secured to a support simply, effectively and inexpensively.

The invention meets this need for a method for securing a sensor to a support, the support including a receiving zone for the sensor and a crimping zone, the sensor comprising a housing provided with a projecting zone,

in which method:
the sensor is moved next to the receiving zone of the support and brought into contact with all or part thereof, and
all or part of the crimping zone is deformed such that said portion(s) of the crimping zone that is/are deformed in this way press(es) against all or part of the projecting zone so as to keep the sensor in position with respect to the support.

Owing to the above method, the sensor is in position relative to the support without there being a need to add an intermediate part, but rather by crimping an existing part.

Such maintenance in position may make it possible to avoid deteriorations in the precision of the sensor despite vibrations. This maintenance of the sensor may also facilitate the connection of electric tabs of the sensor to a leadframe so as to supply electricity to the sensor and allow the measurements that it provides to be used.

The crimping zone of the support may simultaneously: serve to define the receiving zone, and thus maintain that the sensor in certain directions before their deformation, and serve to maintain the sensor in other directions, once the deformation is done.

The deformation may consist of folding down portions of the crimping zone over all or part of the projecting zone of the sensor. Once the deformation is done, the projecting zone may locally be disposed between the receiving zone and the folded down parts of the crimping zone.

The crimping zone may be made from plastic material(s).

All or part of the crimping zone may be deformed by subjecting the latter to heating as well as a mechanical force. A crimping of this zone may thus take place to immobilize the sensor by action on its projecting zone. Only the crimping zone may be subject to thermal and/or mechanical stresses, such that the sensor is not damaged.

The mechanical force may be applied on the crimping zone for a duration greater than that during which said zone is subject to heating. The heating may for example begin while the crimping zone is already subject to the mechanical force.

The temperature applied to deform the crimping zone may vary during heating, in order to increase the effectiveness of the crimping operation while reducing the thermal stresses applied on the sensor. The temperature profile applied may make it possible for the temperature of the crimping zone to be above the glass transition temperature of the material making up said zone, so as to be able to soften without being made fragile, but without this heating leading to excessive heating of the sensor. The heating for example comprises:
a phase for gradually increasing the temperature from a first temperature level to a second temperature level,
a phase during which the second temperature level is applied to deform all or part of the crimping zone, and
a cooling phase.

The first temperature level is for example comprised between 100° C. and 180° C.

The second temperature level may be determined based on the material of the crimping zone, for example being comprised between 220° C. and 260° C.

The heating may comprise a preliminary phase according to which the first temperature level is applied to the crimping zone. The preliminary phase may make it possible to reduce the duration of the heating. The mechanical force applied on the sensor may be comprised between 150 N and 250 N.

The mechanical force and the heating may be applied by a single and same tool, as will be seen below.

The sensor is for example a position sensor. It is in particular a Hall effect sensor.

The housing may have a parallelepiped shape and the projecting zone may be arranged on two different faces, in particular opposite, of the housing. The projecting zone may then extend discontinuously over the housing, for example including several separate portions.

The receiving zone is for example substantially planar and the crimping zone may comprise at least two walls extending substantially perpendicular from the receiving zone. The part of the crimping zone deformed according to the method above may only be that at a distance from the receiving zone, i.e., the distal part of the crimping zone when the latter is observed from the receiving zone.

When the sensor is across from the receiving zone, each wall belonging to the crimping zone may be opposite a face of the housing on which the projecting zone is arranged. Each wall may thus cooperate with a portion of the projecting zone in order to keep the sensor on the support after deformation.

The sensor may comprise a second housing secured to the aforementioned housing, which is then a first housing, and separate from the latter. The two housings may have substantially identical dimensions. The electrical connection of the first housing to the outside may be done via the second housing. One or several first electric tabs may connect the first housing and the second housing. One or several second electric tabs may extend from the second housing to a free end allowing the connection of the sensor to the outside.

The number of first electric tabs may or may not be equal to the number of second electric tabs.

If applicable, the second housing may also have a projecting zone, and the support may comprise another crimping zone cooperating with said projecting zone of the second housing, similarly to what was described above in reference to the first housing to ensure securing of the second housing on the support. Alternatively, the second housing may not be secured directly on the support, the securing instead being done indirectly, owing to the securing described above of the first housing on the support. The projecting zone of the second housing may then allow positioning of the sensor in the receiving zone of the support.

The first housing may comprise the position detection element, in particular the element measuring the magnetic field in the case of a Hall effect sensor, and the second housing may comprise decoupling capacitors, in particular making it possible to meet the requirements in terms of electrostatic discharge and electromagnetic compatibility.

The sensor may have no printed circuit board (PCB).

The support may be integrated into an electromechanical motor vehicle component, in particular a cover of such a component. The electromechanical component is for example an air circuit valve of the heat engine of the vehicle. The sensor may then make it possible to measure the position of the flap of the valve.

The valve is for example a valve regulating the exhaust gas flow rate in the recirculation loop of the air circuit allowing said gases to be reinjected at the intake of the engine (also called “EGR loop”). Alternatively, the valve may be a so-called “three-way” valve disposed at the inlet or outlet of said EGR loop.

The EGR loop may be a “high pressure” or “low pressure” loop.

Also alternatively, the valve may be a choke of the air circuit.

According to another aspect, the invention also relates to an assembly comprising the support and the sensor, the latter being secured using the method described above.

According to another aspect, the invention also relates to a tool for carrying out the method described above, the tool being configured to deform all or part of the crimping zone of the support.

The tool may comprise:
at least one bearing surface, configured to cooperate with all or part of the crimping zone to exert a mechanical force thereon, and
a heating member, configured to apply heating to all or part of the crimping zone.

The tool may comprise control means allowing it to vary the temperature applied on the crimping zone during heating, in particular allowing the application of the different phases set out above.

The tool may comprise a guide member associated with the bearing surface, so as to guide, in one or more predefined directions, the material movement of the crimping zone caused by the deformation of all or part thereof. This guide surface makes it possible for the deformation of the crimping zone to cause the latter to be folded down across from the projecting zone so as to come into contact therewith and exert a stress on the latter oriented toward the receiving zone. The sensor may thus be secured to the support with zero play.

The invention may be better understood upon reading the following description of one non-limiting example embodiment thereof and upon examining the appended drawing, in which:

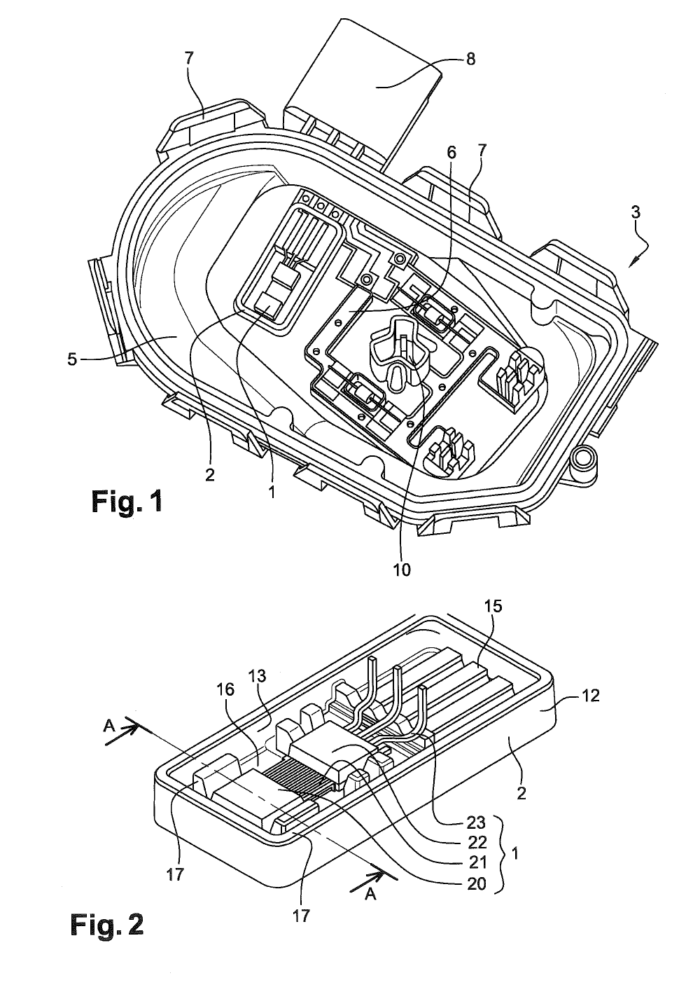

FIG. 1 diagrammatically shows an example embodiment within which the invention may be implemented,

FIG. 2 is a detail of FIG. 1,

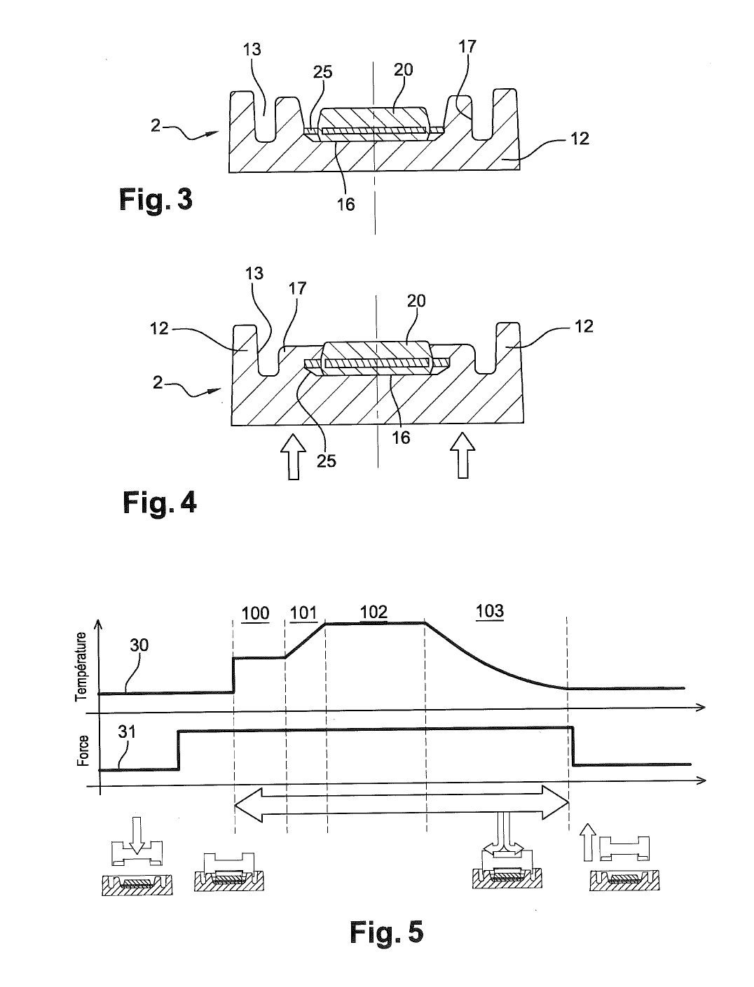

FIG. 3 is a sectional view along A-A of FIG. 2, showing the support and the sensor before securing,

FIG. 4 shows the support and the sensor of FIG. 3 after the sensor has been secured on the support,

FIG. 5 shows the evolution of the mechanical and thermal stresses applied during the implementation of the method, and

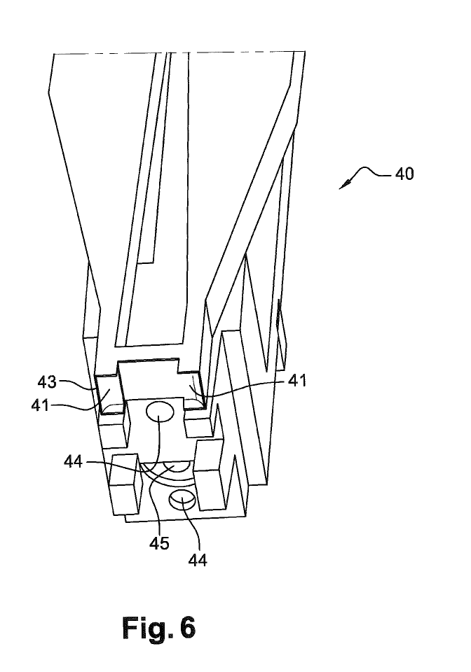

FIG. 6 shows an example tool to be used to implement the method for securing the sensor on the support.

FIG. 1 shows an example environment within which the method according to the invention may be implemented.

In the described example, the method makes it possible to secure a sensor 1 on a support 2 integrated into a cover 3 of an air circuit valve of a heat engine. The valve is for example a valve regulating the EGR gas flow rate in a recirculation loop or a valve regulating the flow rate of these gases reinjected at the intake of the engine.

In the considered example, the cover 3 comprises a plastic wall 5 on which electrically conductive tracks 6 are arranged.

In the described example, the cover 3 also comprises mechanical interface means 7 with the valve body (not shown), for example by snapping, and electrical interface means 8 with an electricity supply device and/or control device (not shown).

As shown in FIG. 1, the cover can also comprise a bearing 10 allowing it to be positioned correctly relative to the valve body owing to an intermediate shaft (not shown). This intermediate shaft here is part of a transmission stage at the flap of the valve for the movement generated by an electric motor.

The content of the application filed in France by the Applicant on Oct. 12, 2012 under number 12 59740 is incorporated into this application by reference, at least regarding the grounding means via the intermediate shaft of the electric motor used to move the flap of the valve.

The support 2 shown in more detail in FIG. 2 can be attached on the cover 3 or form a part thereof.

As shown in FIG. 2, the support 2 may have a peripheral rim 12 extending around said support 2 and defining an inner space 13.

In the considered example, part of this inner space 13 forms a housing for the sensor 1, while another part of the space 13 receives electrical tracks 15 allowing the electrical connection of the sensor 1 to the connection means 8 of the cover 3.

As shown in FIG. 2, the bottom of the part of the inner space 13 forming the housing for the sensor 1 can be planar and define a receiving zone 16 for the sensor 1.

In the considered example, two walls 17 extend from the receiving zone 16, substantially perpendicular to the receiving zone 16, and these walls 17 here are substantially parallel to one another. The walls 17 form a crimping zone, as explained below.

These walls 17 here are made from plastic and may or may not be made in a single piece with the receiving zone 16.

As shown in FIG. 2, in the described example, the sensor 1 assumes the form of two housings 20 and 21 connected to one another electrically and mechanically by first electric tabs 22. The first electric tabs 22 can be rigid, such that the first housing 20 is secured to the second housing 21. Each housing 20 or 21 may be obtained by molding plastic material(s).

In this example, each of the housings 20 or 21 has a same parallelepiped shape, having the same dimensions from one housing to the next. In the considered example, the first housing 20 serves to house an element for detecting a magnetic field in order to detect the position of the flap of the valve. The second housing 22 in this example houses decoupling capacitors.

In this example, the sensor 1 also comprises second electric tabs 23 intended to allow the electrical connection of the second housing 21, and therefore the sensor 1, to the electrical tracks 15.

The sensor is for example that marketed by the company MELEXIS® under the commercial reference MLX90364 Triaxis®.

As shown in FIG. 3, the first housing 20 bears a projecting zone 25, said zone 25 being thus named because it protrudes relative to the rest of the outer surface of said housing 20. In the considered example, this projecting zone 25 extends over two opposite faces of the housing 20, then comprising two portions each supported by one of these faces. The second housing 21 in this example also comprises a projecting zone 25.

When the sensor 1 is received in the inner space 13, each wall 17 is disposed near a portion of the projecting zone 25.

We will now describe, in reference to FIGS. 3 to 5, a method for securing the sensor 1 on the support 2 according to the invention.

After a preliminary phase consisting of bringing the sensor 1 into contact with the receiving zone 16, a mechanical force and heating are applied on the walls 17 so as to deform them in order to fold them down toward the projecting zone 25.

FIG. 5 shows the evolution over time of the application of the mechanical force on the walls 17, along a curve 30, and the evolution over time of the heating of the walls 17, along a curve 31.

As shown in FIG. 5, a mechanical force is first applied on the distal part of the walls 17. A preheating phase 100, during which a first temperature level is applied to the walls 17, next occurs. This first temperature level is for example comprised between 100° C. and 180° C.

During a second phase 101, an increase, for example linear, of the temperature applied to the walls 17 from a first temperature level to a second temperature level occurs. The second temperature level is for example comprised between 220° C. and 260° C.

During a third phase 102, the second temperature level is applied to the walls, the temperature remaining substantially constant during this step 102. During a fourth phase 103, cooling of the walls 17 is done, for example by blowing cool air. At the end of the fourth phase 103, the temperature of the walls 17 may be substantially equal to that which they had at the beginning of the first phase 100. As shown in FIG. 5, the mechanical force may be applied on the walls 17 during all of the phases 100 to 103.

The combined application of a mechanical force and heating on the walls 17 makes it possible to deform the distal part of these walls 17, such that these distal parts are folded down toward the projecting zone 25. The walls 17 then assume a curved shape to exert a force on the projecting zone 25, and this force is oriented toward the receiving zone 16. This force thus oriented makes it possible to keep the sensor 1 in position on the support 2.

At the end of the method according to the invention, the projecting zone 25 is locally disposed between the receiving zone 16 and the folded down part of the walls 17. We will now describe, in reference to FIG. 6, an example tool 40 able to be used to implement the method described above.

This tool 40 makes it possible to deform all or part of the walls 17 of the support 2.

In the considered example, the tool 40 comprises several bearing surfaces 41, each one being configured to cooperate with the end of the distal part of a wall 17 to exert a mechanical force thereon. This bearing surface 41 is for example planar, as for example is the free end of each distal part of the wall 17.

In the described example, a guide member 43 is associated with each bearing surface 41. The guide member 43 here is a rib extending around part of the bearing surface 41, thus forming a barrier along part of the perimeter of this bearing surface 41. The guide member 43 in this example comprises three successive segments forming a right angle in pairs.

When the end of a distal part of a wall 17 is in contact with the bearing surface 41, the guide member 43 extends, where it exists, along that end. The deformation of the distal part of a wall 17 under the combined application of heating and a mechanical force is thus prevented in certain directions due to the presence of these directions of the guide member 43, which acts as a barrier. This deformation is then guided toward the other directions due to the absence of the guide member 43 for those directions.

The guide member 43 here is configured such that the deformation of the distal part of the corresponding wall 17 occurs toward the projecting zone 25. The material of the walls 17 thus deformed then stresses the projecting zone 25, as explained above. The deformed material advantageously places itself, owing to the tool 40, over the projecting zone 25 with a sufficient thickness and without burrs at the end.

In the considered example, the tool 40 also comprises a heating member, not shown in FIG. 6, configured to apply heating over all or part of the crimping zone 17.

Two holes 44 may make it possible to blow hot air onto the walls 17 so as to carry out the phases 100 to 102 described in reference to FIG. 5, while another hole 45 may make it possible to blow cold air onto the walls 17 so as to carry out the phase 103.

The tool may also comprise control means (not shown) allowing it to vary the temperature applied on the crimping zone during the heating, in particular allowing the application of the various phases set out above.

The invention is not limited to the examples described above.

The expression “comprising a” must be understood as being synonymous with the expression “comprising at least one”, unless otherwise specified.

1. A method for securing a sensor to a support, the support including a receiving zone for the sensor and a crimping zone, the sensor comprising a housing provided with a projecting zone, the method comprising:
moving the sensor next to the receiving zone of the support and bringing the sensor into contact with all or part thereof; and
deforming all or part of the crimping zone by heating and a applying a mechanical force to the crimping zone such that said deformed portion(s) of the crimping zone press against all or part of the projecting zone so as to keep the sensor in position with respect to the support.

2. The method according to claim 1, wherein the temperature applied to deform the crimping zone varies during heating.

3. The method according to claim 2, wherein the heating comprises:
a phase for gradually increasing the temperature from a first temperature level to a second temperature level,
a phase during which the second temperature level is applied to deform all or part of the crimping zone, and
a cooling phase.

4. The method according to claim 3, wherein the heating further comprises a preliminary phase during which the first temperature level is applied to the crimping zone.

5. The method according to claim 1, wherein the sensor is a position sensor.

6. The method according to claim 1, wherein the housing has a parallelepiped shape and the projecting zone is arranged on two different faces, in particular opposite, of the housing.

7. The method according to claim 1, wherein the receiving zone is substantially planar and wherein the crimping zone comprises at least two walls extending substantially perpendicular from the receiving zone.

8. The method according to claim 6, wherein when the sensor is across from the receiving zone, each wall is opposite a face of the housing on which the projecting zone is arranged.

9. The method according to claim 1, wherein the support is integrated into an electromechanical motor vehicle component.

10. The method according to claim 9, wherein the electromechanical component is an air circuit valve of the heat engine of the motor vehicle.

11. A tool for carrying out the method according to claim 1, the tool being configured to deform all or part of the crimping zone of the support.

12. The tool according to claim 11, comprising:
at least one bearing surface, configured to cooperate with all or part of the crimping zone to exert a mechanical force thereon; and
a heating member, configured to apply heating to all or part of the crimping zone.

13. The tool according to claim 12, further comprising a guide member associated with the bearing surface, so as to guide, in one or more predefined directions, the material movement of the crimping zone caused by the deformation of all or part thereof.
